(19) United States
(12) Patent Application Publication
(10) Pub. No.: US 2026/0089556 A1
(43) Pub. Date: Mar. 26, 2026

(54) METHOD AND SYSTEM FOR DATA MANAGEMENT

(71) Applicant: FLASH NETWORKS, LTD, Ra anana (IL)

(72) Inventors: Ofer Gottfried, Batzra (IL); Assaf Benedic, Tel Aviv (IL); Eyal Leyzerovich, Ramat-Gan (IL); Alon Faiman, Rishon Lezion (IL); Amichai Hadad, Hashmonaiim (IL)

(73) Assignee: FLASH NETWORKS, LTD, Ra anana (IL)

(21) Appl. No.: 18/893,194

(22) Filed: Sep. 23, 2024

(51) Int. Cl. H04W 28/02; H04W 28/06

(52) U.S. Cl. CPC H04W 28/0289; H04W 28/06

(57) ABSTRACT

A technique is disclosed for downloading large flow (LF) of data packets toward a certain mobile device (MD) while sharing the bandwidth (BW) with flows toward other MDs. The disclosed technique switches between two bitrates. It may start the download process with a high bitrate for s certain period of time (foreground) and then switch to a reduced bitrate for another period of time (background) and vice versa.

### FIELD OF THE DISCLOSURE

The present disclosure relates to the field of data communication over a packet switch network such as but not limited to an Internet Protocol (IP) network. More particularly the disclosure relates to communicating IP packets over a cellular network such as but not limited to General Packet Radio Service (GPRS), Universal Mobile Telecommunications System (UMTS) or Long-Term Evaluation (LTE) network, New Radio (NR) network, or over Terrestrial networks

Furthermore, the disclosure relates to downloading Large Flows (LF) over radio links between a base station and a plurality of mobile devices (MD) that are currently associated with that base station (BS).

### DESCRIPTION OF BACKGROUND ART

When a plurality of MDs, which are currently associated with a certain BS, require to share the radio resources of that BS, then a scheduler is needed in order to allocate the radio resources between the plurality of MDs.

In order to provide fairness, a common scheduler may use one or more of common scheduling techniques. Techniques such as but not limited to “Frame Level Scheduler” (FLS); Max-Min Fairness; Round Robin; etc. Those techniques are well known to a person with ordinary skill in the art and will not be further disclosed.

Common scheduling techniques take into consideration the quality of the connection with the MD, the status of the channel, the rate that is used by the MD, etc. In addition, a common scheduler needs to maneuver between maximum throughputs versus fairness. Thus, during congestion conditions the transmitted bitrate of each flow can be reduced. Reducing the transmitted bitrate of certain flows may reduce the quality of experience (QoE) of the user that obtains this flow. Reducing the transmitted bitrate of a video file may cause stalls or lead the MD to switch to a lower video resolution affecting the QoE of the user. Thus, an improved downloading algorithm is needed in order to support congestion conditions without reducing the quality of experience (QoE) of a user of a MD.

Further, observation of the traffic over cellular networks shows that the majority of customers' transactions consist of small flows and only the minority of customers' transactions consist of LF. LF may comprise video files, software-updates, etc..

### BRIEF SUMMARY

The needs and the deficiencies that are described above for keeping the QoE of a subscriber are not intended to limit the scope of the inventive concepts of the present disclosure in any manner. The needs are presented for illustration only.

An example embodiment of the disclosed technique is configured to identify that a flow, which is currently downloaded, is a LF. The minimum size of a LF is a configurable parameter that can be set by a user of the system. The downloading time of LF may depend on the available throughput.

We observe a plurality of downloading sessions from a plurality of servers to a plurality of mobile devices (MDs) over a plurality of connections and networks conditions. In those observations we found that a download session of a LF may start with a continuous download that takes few seconds, between 1 and 5 seconds for example, in which a large number of bytes, 1 MB for example, has been downloaded. Next, the download process may continue by downloading a smaller number of bytes, for example 0.2 MB every few seconds, between 5 to 10 seconds, for example, until the end of the flow.

TikTok application, for example, may start with a continuous download, of a large number of bytes, for a period of 15 seconds and will continue with downloading of small number of bytes every 5 to 10 seconds. TikTok is an online video platform (OVP) that enables users to upload, convert, store, and play back video content on the Internet. TikTok is owned by ByteDance Ltd. a Chinese internet technology company.

Disney+ application, for example, may start with a continuous download of a large number of bytes and will continue with downloading of small number of bytes every 3 seconds. Disney+ is an American subscription video on-demand over-the-top streaming service owned and operated by the Disney Entertainment division of The Walt Disney Company.

YouTube application may start with a continuous download of a large number of bytes, for a period of 10-30 seconds and will continue with downloading of small number of bytes every 7 to 20 seconds. YouTube LLC is a US video sharing domain currently operates as one of Google's subsidiaries.

An example embodiment of the disclosed technique can be communicatively coupled between an Internet protocol (IP) network and one or more base stations of the cellular network. The base stations can be gNodeB in NR network, eNodeB in LTE network, UTRA in UTMS, or base transceiver station (BTS) in GSM networks, etc. LTE stands for Long-Term Evolution; UTMS stands for Universal Mobile Telecommunications System; UTRA stands for UMTS Terrestrial Radio Access. NR stands for New Radio. The functionality of those cellular network devices are well known to a person with ordinary skill in the art and will not be further discussed.

An example embodiment of the disclose technique can be configured to implement the congestion policy of a cellular operator. It can be configured to identify periods of congestion over a certain base station. If the congestion is high, then estimate the size of a flow that is carried over each flow from a plurality of flows of DL packets (downloaded packets) transmitted toward a plurality of MDs. Upon determining that a currently downloaded flow is large, an example embodiment of the disclosed technique can be configured to reduce the transmitting bit rate of that flow in order to allow other flows to get radio resources.

An example embodiment of the disclosed technique may use a LF handling module (LFH). An example of LFH may comprise a LF-detector (LFD) and a LF manipulator (LFM). An example of LFD may be configured to determine that a flow, which is currently downloaded to a certain user, is a LF. In order to be useful, the detection has to be done during a short period of time from the beginning of the download process. We refer to this period as the detection-period (DtP). A reasonable DtP can be in the range of 1 to 60 seconds from the beginning of the download process. An example embodiment of the disclosed technique may define the DtP as 60 seconds. If during the 60 seconds the number of downloaded bytes is above a certain threshold (1 MB, for example) then the flow can be defined as a LF.

Some example embodiments of the disclosed technique may analyze the pattern of a flow of downloaded packets. We found that downloading of a LF may start with a burst of packets that may take few tens of seconds until a buffer, at receiving MD, is full. This period of time can be referred to as the Foreground (FG) period. Next a period of Background (BG) may be started, during the BG period the utilized bandwidth is reduced, and the flow may carry one or more packets each time the receiving MD asks for more data.

The FG period can be in the range of 1 to 30 seconds, 10 seconds, for example. The BG period can be in the range of 1 to 90 seconds, 30 seconds, for example. This pattern may continue as long as the download session of a LF continues. Thus, a FG period will be followed by a BG period and so on.

Reducing the transmitting rate of a LF, during the BG period, may not affect the QoE of the user since the buffer at the MD has been loaded during the FG period. Thus, during the BG period, of that flow, packets are transmitted toward the MD but in a lower bitrate. Along with the disclosure and the claims, the terms “toward” and “in the direction of” can be used interchangeably.

In some mobile networks the LFD can be installed in an eNodeB as a resource allocation module running on one or more processors of the eNodeB. In other cellular networks the LFD can be installed in an access network operator premises (ANOP) as download optimizer server. Along with the disclosure and the claims, the terms cellular network, mobile network and radio network can be used interchangeably.

An example of a download optimizer server (DOS) can be configured to implement the download policy of the cellular operator. An example of a download optimizer server can be configured to identify that the current flow, which is carried over a certain flow from a plurality of flows of DL packets (downloaded packets) transmitted toward a plurality of MDs, is a LF. An example of such a DOS may comprise a bank of LFHs. Each LFH can be allocated to a new flow at the beginning of the flow.

An example of a LFD can be configured to obtain periodically a traffic-report (TrR). In some example embodiments a TrR may be obtained every second, in other example embodiments the TrR can be obtained every 1 second, etc. An example of TrR may describe the bitrate as a function of time. In some embodiments the time period can be divided into segments. Each segment can represent 100 milliseconds, for example. In other example embodiments, each segment may represent 10 milliseconds, for example. The units in the bitrate axis can be expressed in 100 Mbyte per second, for example. In another example embodiment the TrR can be a graph in which the horizontal axis (X) describes the time in time-units (milliseconds, for example) and the vertical axis describes the bitrate in Mbits per second.

After analyzing a plurality of TrRs we found that a download session of a LF will start with a FG period, (graph1) followed by a BG period. Each period may comprise one or more Sections as illustrated in the graph. Based on graph 1 we define the following terms:
Section Definitions:
   Section download bytes: the amount of downloaded bytes from the beginning of the section.
   Peak bandwidth: the highest bandwidth reached.
   Section Peak: the highest bandwidth seen during the section's lifetime.
   Section Average: the average bandwidth seen during the section's lifetime.
   %-from-Max: A percentage from the Section Peak.
   Minimum data: the minimal number of bytes downloaded during a session (configurable).
   When bandwidth drops below the %-from-Max, the search for the next section begins.
   Minimum data is surpassed. Section should be longer than a second.
Mutual Section and Traffic Report Definitions:
   threshMin—a configurable bitrate threshold in Mbps.
   Quiet time: A segment bandwidth lower than or equal to a threshMin.
   Active time: a segment bandwidth higher than threshmin.

Pressure Gauge holds the percentage of active time from the last three (configurable) seconds (denoted by the black rectangle (the sliding window) in the graph that “slides” across it). Other example embodiments of the disclosed technique the sliding window may cover other number of seconds, 5 seconds for example.

We use the value of the Pressure Gauge in order to determine when to switch from FG to BG and vice versa. If the Pressure Gauge is above a certain threshold (TH1). In some embodiments TH1 can be 80 % for example. Thus, if the Pressure Gauge of a certain flow is above 80%, then the section can be defined as a Foreground (FG) section. Upon determining that the section is a FG section, the transmitting rate of the LF remains as the maximum rate which is allowed by the network.

We found that during downloading of LF if the value of the Pressure Gauge is below a second threshold (TH2) then the section can be defined as a Background (BG), thus, the transmitting rate of the LF may be reduced by few tens of percentages, 20% for example. In some embodiments TH2 can be 30 % for example. Thus, if the Pressure Gauge of a certain flow is below 30%, then the section can be defined as a Background (BG) section.

Reducing the transmitting rate can be implemented by reducing Receiving-window TCP flag toward the internet server in order to reduce the bitrate that is used by the Internet server for downloading the data packets of the LF. Another example embodiment of the disclosed technique may reduce the transmitting bitrate of a flow that is transmitting from the DOS toward a MD.

The foregoing summary is not intended to summarize each potential embodiment or every aspect of the present invention, and other features and advantages of the present invention will become apparent upon reading the following detailed description of example embodiments with the accompanying drawings and appended claims.

Furthermore, although specific examples of embodiments are described in detail to illustrate the inventive concepts to a person with ordinary skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the disclosed embodiments with the accompanying drawings and appended claims.

### BRIEF DESCRIPTION OF THE DRAWING

Exemplary embodiments of the present disclosure will be understood and appreciated more fully from the following detailed description, taken in conjunction with the drawings in which.

FIG. 1 illustrates a block diagram with relevant elements of an example of a mobile communication system in which an embodiment of the present disclosure can be implemented for handling LF.

FIG. 2A illustrates a block diagram with relevant elements of a network architecture in which an example of DOS is associated with an eNodeB;

FIG. 2B illustrates a block diagram with relevant elements of a network architecture in which an example of DOS is associated with an ANOP;

FIG. 3 illustrates a block diagram with relevant elements of an example of a DOS.

FIG. 4 illustrates a flowchart with relevant actions of an example of process that can be used by a manager module (MM) for routing DL packets; and

FIG. 5 illustrates a flowchart with relevant actions of a process that can be executed by a LFH of a DOS for determining when to switch from FG to BG and vice versa.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor.

In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description, the words “unit,” “element,” “module” and “logical module” may be used interchangeably. Anything designated as a unit or module may be a stand-alone unit or a specialized or integrated module. A unit or a module may be modular or have modular aspects allowing it to be easily removed and replaced with another similar unit or module. Each unit or module may be any one of, or any combination of, software, hardware, and/or firmware, ultimately resulting in one or more processors programmed to execute the functionality ascribed to the unit or module. Additionally, multiple modules of the same or different types may be implemented by a single processor. Software of a logical module may be embodied on a computer readable device such as a read/write hard disc, CDROM, Flash memory, ROM, or other memory or storage devices, etc. In order to execute a certain task a software program may be loaded to an appropriate processor as needed. In the present disclosure the terms task, method, process can be used interchangeably. In the present disclosure the verbs transmit, transfer or be placed in a queue can be used interchangeably. Packets that are placed in a queue are sent as soon as possible.

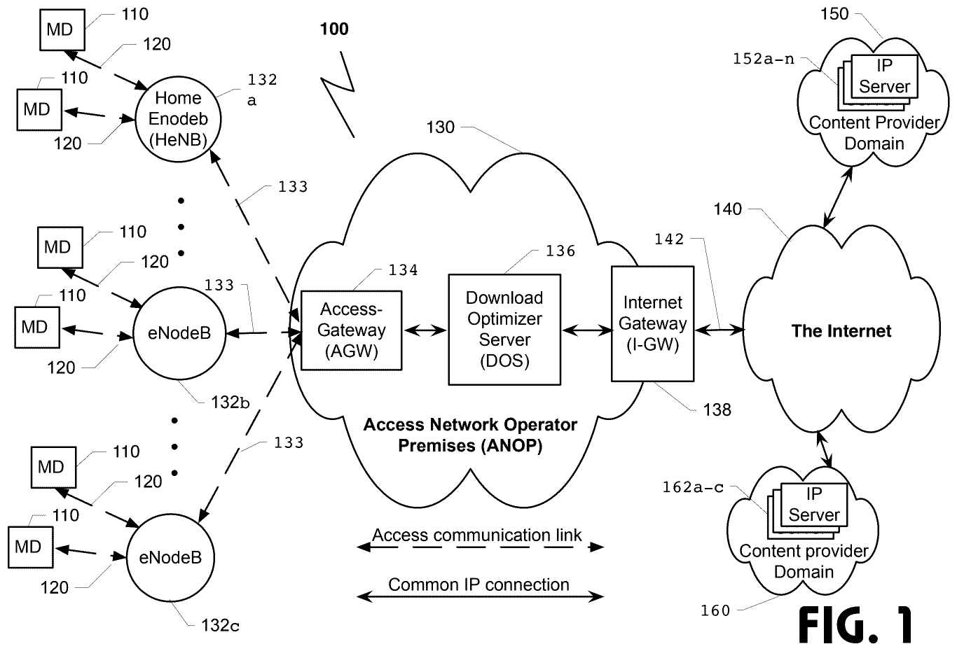

FIG. 1 illustrates a block diagram with relevant elements of an example of a mobile communication system 100 in which an embodiment of the present disclosure can be implemented for handling LF. Communication system 100 can be configured to handle packets of LF. Communication system 100 can comprise an Access Network Operator Premises (ANOP) 130, a plurality of mobile-devices (MDs) 110, a plurality of intermediate nodes 132a-c, the Internet 140, one or more domains 150 and 160, each domain has one or more IP servers 152a-c and 162a-c respectively. Domains 150 and 160 can be associated with content providers such as but not limited to YouTube LLC of Facebook Inc. The intermediate nodes 132a-c can comprise: Home eNodeB (HeNB) 132a; eNodeB 132b&c, for example.

The ANOP 130 can be connected to the Internet 140 via an I-GW 138 and a communication link 142. An example of I-GW 138 can be configured to communicate with a NAT in order to get a public IP address for a new flow. The NAT can be a Carrier-Grade NAT (CGN). The CGN can reside in the ANOP 130. An example of ANOP 130 can be the access network of a GPRS cellular operator, LTE cellular operator, NR cellular operator, etc.

A few non-limiting examples of typical mobile-devices (MDs) 110 can be: a laptop, a mobile phone, a PDA (personal digital assistance), a smart phone, a tablet computer, etc. A smartphone is a mobile phone with an advanced mobile operating system that combines features of a personal computer operating system with other features useful for mobile or handheld use. Each MD 110 may employ a video player such as but not limited to TikTok application, Disney+ application, “YouTube player” or “Facebook player”, etc.

An MD 110 can be connected to an access gateway (AGW) 134 via intermediate nodes such as eNodeB 132b&c or Home eNodeB (HeNB) 132a and a backhaul network 133. A non-limiting example of an AGW 134 can be an S-GW or P-GW. Along the disclosure and the claims the term AGW and S-GW can be used interchangeably. The connection between an MD 110 and the intermediate nodes 132a-c can be implemented by cellular links 120.

An ANOP 130 can provide different services to the plurality of MDs 110. Few non-limiting examples of services provided by the ANOP 130 can comprise: delivering access to the Internet, spam filtering, content filtering, bandwidth consumption, distribution, transcoding, rating adaptation, power saving, etc.

Among other elements, an example ANOP 130, which is configured to implement an example embodiment of the disclosed technique, may comprise an example embodiment of a Download-Optimizer-server (DOS) 136. An example of DOS 136 can be a TCP and/or UDP proxy located between one or more of the MDs 110 via AGW 134 and one or more IP servers via I-GW 138. An example of DOS 136 can be configured to manipulate the rate of download traffic of LF.

Among other tasks, an example of AGW 134 can be configured to identify a requesting MD 110 at its ingress to the ANOP 130, to process the data traffic to or from the plurality of MDs 110 via the one or more intermediate nodes 132a-c. In the direction from the MD 110 toward the internet 140, the AGW 134 can be configured to transfer the IP traffic toward I-GW 138 via DOS 136. An example AGW 134 can be an S-GW for an LTE network, UPF for a NR network, another example of AGW can be P-GW for an LTE network or SMF for a NR network. The AGW 134 can be configured to identify the subscriber and accordingly can determine whether the subscriber is allowed to get the required access to the network and what services the subscriber is entitled to receive, etc. In some embodiments of system 100, the AGW 134 can be configured to handle the mobility management of MDs 110 and implement a signaling channel over the backhaul network 133 for paging and mapping each MD 110 to its currently associated eNodeB or HeNB 132a-c.

The I-GW 138, at the other side of ANOP 130, may participate in a process of allocating one or more public IP addresses to the requesting MD 110 to be used during the current transaction. In some embodiments I-GW 138 may act also as a router, for example. The I-GW 138 can route IP data packets to and from the plurality of IP servers 152a-c and 162a-c via the Internet 140. The communication between the I-GW 138 and the Internet 140 can be based on Internet protocol (IP). A person with ordinary skill in the art is familiar with the functionality of S-GW, P-GW and I-GW; therefore it will not be further disclosed.

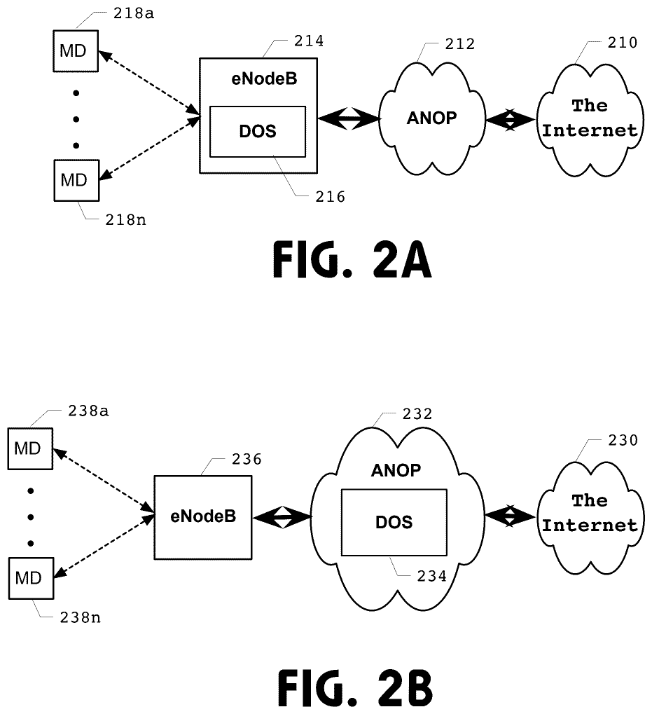

Among other tasks, an example embodiment of DOS 136 can be configured to obtain indication that the current congestion over a certain base station 132a-c is high. If the congestion is high, then DOS 136 may estimate the size of a flow that is carried over one or more flows from a plurality of flows of DL packets (downloaded packets) that are transmitted toward the plurality of MDs 110 via that base station 132a-c. Upon determining that a currently downloaded flow is a LF, an example embodiment of DOS 136 can be configured to reduce the transmitting bit rate of that flow in order to allow other flows to get radio resources. More information on the operation of an example DOS 136 is disclosed below in conjunction with FIG. 2A to FIG. 5.

FIGS. 2A and 2B illustrate block diagrams with relevant elements of two examples of network architecture in which example embodiments of DOS 216 or 234, respectively, can be implemented. FIG. 2A illustrates a block diagram of a network architecture in which DOS 216 can be associated with an eNodeB 214. Such architecture may comprise the Internet 210 that is communicatively coupled to eNodeB 214 via the ANOP 212.

A LF of DL packets that carries data can travel from a content server (not show in the figure) that resides over the Internet cloud 210 via the cellular ANOP 212 to the eNodeB 214 and from the eNodeB the packets can be transmitted toward the relevant MD 218a-n. In eNodeB 214 the DL packets can be transferred via DOS 216 toward the relevant MD 218a-n. An example of DOS 216 can be configured to determine whether the flow is a LF and if it is a LF the DOS 216 may manipulate the transmitting rate of that flow. The decision whether the flow is a large flow can be based on the domain that delivers this flow of DP.

Usually packets that are downloaded from “YouTube” carry video data, which is typically carried over a LF. Other embodiments of the disclosed technique may analyze the pattern of a flow or the network signature of the flow in order to determine the type of content that is carried over that flow of downloaded packets. We found that downloading of a LF may start with a burst of packets that may take few tens of seconds until a buffer, at receiving MD, is full. This period of time can be referred to as the Foreground (FG) period. Next a period of Background (BG) may be started, during the BG period the utilized bandwidth is reduced, and the flow may carry one or more packets each time the receiving MD asks for more data. Yet some embodiments of DOS 216 may identify the type of content based on the protocol that is used, etc.

Upon determining that a currently downloaded flow is a LF, an example embodiment of DOS 216 can be configured to reduce the transmitting bit rate of that LF in order to allow other flows to get radio resources from eNodeB 214. Reducing the transmitting rate can be in the range of few tens of percentages, 10% to 40%, 20% for example.

An example of DOS 216 can be configured to reduce the transmitting range by reducing the Receiving-window TCP flag that is sent toward the internet server (not shown in the figure) that resides in the Internet 210. Another example embodiment of DOS 216 may have a plurality of LFHs. Each FLH can be associated with a FIFO (First In First Out), not shown in the figure, which store the obtain packets carried over the LF and may transmit those packet in reduced bit rate toward the relevant MD 218a-n.

Other example embodiments of DOS 216 can be configured to manage the uplink traffic of requests from the MDs 218a-n toward the content servers (not show in the figure) that resides over the Internet cloud 210. Requests from a certain MD 218a-n can be stored in a FIFO at the DOS 210 and be transmitted toward a relevant content server at the Internet cloud 210. In such embodiment the frequency of the read clock from the FIFO is reduced compare to the frequency of the write clock, for example.

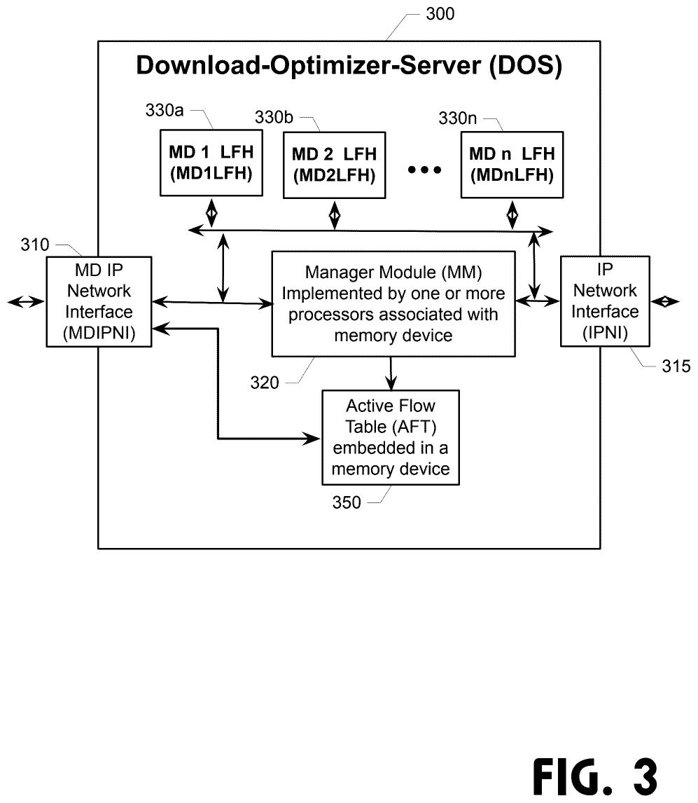

FIG. 2B illustrates a block diagram of a network architecture in which an example of DOS 234 is associated with the ANOP 232. DOS 234 resides at the ANOP 232 and is communicatively coupled between the eNodeB 236 and the Internet 230. DOS 234 can be configured to identify whether a flow of DL packets toward a certain MD 238a-n is a LF. If the flow is a LF, then DOS 234 may manipulate the transmitting rate of that flow. The decision whether the flow is a large flow can be based on the domain that delivers this flow of DP. More information on the operation of an example of DOS 216 or DOS 234 is disclosed below in conjunction with FIG. 3 to FIG. 5.

FIG. 3 depicts a block diagram with relevant elements of an example embodiment of a DOS 300. For readability and instructional purposes the disclosed embodiment is divided into few logical modules. Further, an example of DOS 300 may comprise one or more processors, computer readable non-transitory memory device such as a read/write hard disc, CDROM, Flash memory, ROM, or other non-transitory memory or storage devices, etc. Software of a logical module may be embodied on one of the computer readable non-transitory storage medium. In order to execute a certain task, a software program may be loaded to an appropriate processor as needed.

An example of DOS 300 can comprise few logical modules. Modules such as but not limited to: an MD-IP network-interface (MDIPNI) 310, a Manager module (MM) 320, an active flow table (AFT) 350, one or more LFH 330a-n, each LFH can be associated with an MD 218a-n (FIG. 2A). MD1LFH 330a can be associated with MD 218a; MD2LFH 330b can be associated with MD 218b, etc. Each LFH 330a-n may obtain DL packets received from one of the IP servers 152a-n or 162a-n (FIG. 1) that is associated with the relevant flow. In addition DOS 300 may comprise an IP network interface (IPNI) 315.

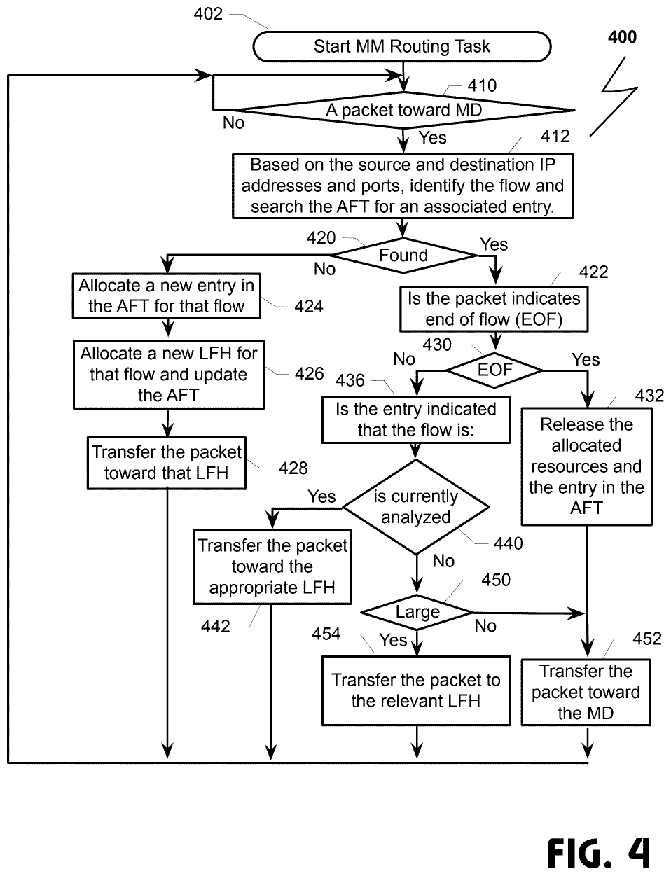

An example of AFT 350 can be embedded in a computer readable non-transitory memory device and can be arrange as a table in which each row can be associated with an active flow. In addition AFT 350 can comprise a plurality of columns. The first four columns can be allocated to the identifiers of a flow (IP addresses and ports). The following column can be associated with indications about the relevant flow. Indications such as but not limited to whether the flow is currently analyzed. Whether the flow is a LF or not. More information about AFT 350 is disclosed below in conjunction with FIG. 4.

An example of IPNI 315 may receive packets from I-GW 138 (FIG. 1) based on the header of the packet, the IPNI 315 can identify the flow to which the packet belongs. Then, the AFT 350 can be searched looking for an entry that is associated with that flow. Based on the found entry the packet can be transferred toward the relevant LFH 330a-n and MM 320 can be informed. In the other direction requests, obtained from the MDs 110 (FIG. 1), are transferred via MDIPNI 310, MM 320 and via IPNI 315 toward IP servers 152a-c or 162a-c via the Internet 140 (FIG. 1).

MM 320 can be implemented by one or more processors. Software that is needed for the operation of the one or more processors may be embodied on a computer readable non-transitory memory device such as but not limited to a read/write hard disc, CDROM, Flash memory, ROM, or other memory or storage devices, etc. In order to execute its tasks one or more software programs may be loaded to one or more processors of the MM 320.

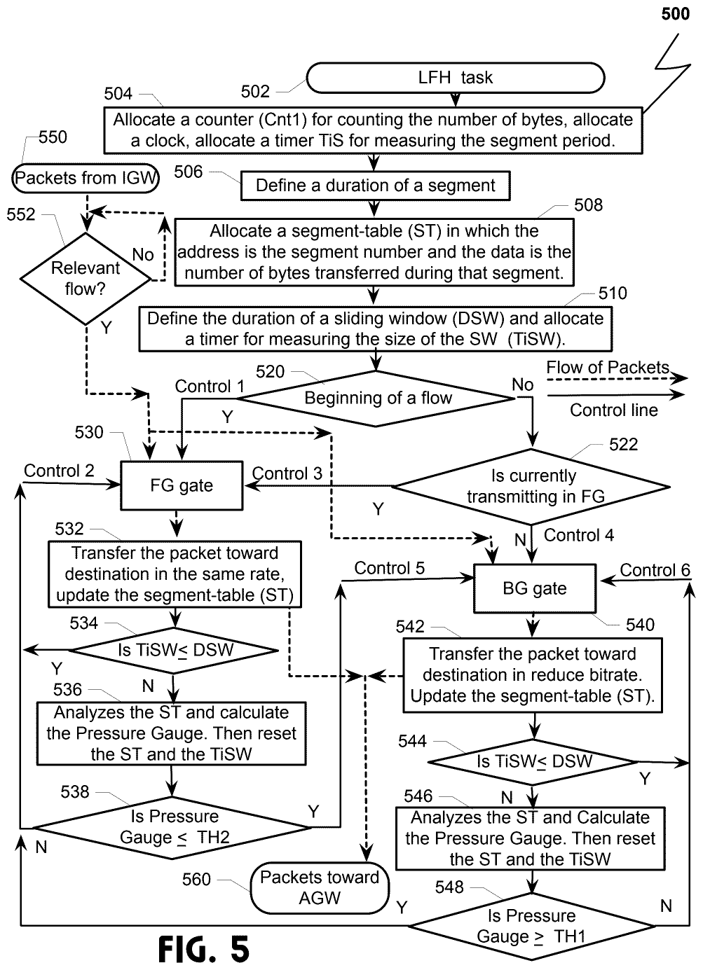

In some embodiments of DOS 300 after loading the software of MM 320, the MM 320 can be configured to handle new flow, to route packets of exiting flow according to indications that are written in the relevant entry in AFT 350. More information on this kind of activity of MM 320 is disclosed below in conjunction with FIG. 4. Further, MM 320 can be configured to manage the transmitting of a LF. MM 320 can determine whether to send the packets of a LF in the FG or the BG. More information on this kind of activity of MM 320 is disclosed below in conjunction with FIG. 5.

Referring now to FIG. 4 that illustrates a flowchart with relevant actions of an example of process 400 that can be implemented by an example of a manager module (MM) 320 (FIG. 3) for routing DL packets toward MDs 110 (FIG. 1). After initiation 402 process 400 may wait 410 for a DL packet or may approach the next DL packet from it's queue. Based on the source and the destination IP address and port of that packet the AFT can be searched 412 looking for an entry that is related to that flow.

At block 420 a decision is made whether 420 an entry in AFT is found. If 420 not, then a new entry, in the AFT 350 (FIG. 3), is allocated 424 for that flow. Next, a new LFT task is allocated for handling this flow and the entry in the AFT is updated 426 with parameters of the allocated LFH. Then, the packet can be transferred 428 toward that LFH and process 400 may return to block 410 for handling the next packet. Along the description and the claims of this document the terms task, process, method, may be used interchangeably.

If 420 an entry in the AFT is found, then the packed is parsed 422 and a decision is made whether the packet indicates the end of flow (EOF). If 430 it is EOF, then at block 432 the resources that were allocated to that flow are released and the entry in the AFT is released too. Next, the packet is transferred 452 toward the relevant MD and process 400 may return to block 410 for handling the next packet.

If 430 the packet is not EOF, then based on the entry in the AFT the status of that flow is checked 436. If the flow is currently analyzed 440, then based on the information stored in the AFT the packet is transferred 442 toward the appropriate LFH and process 400 return to block 410. If 440 the flow is not currently analyzed, then a decision is made 450 whether the relevant flow is a LF. If 450, the flow is not a LF the packet is transferred 452 toward the relevant MD. If 450, the flow is a LF the packet, based on the entry in the AFT, is transferred 454 toward the queue of the relevant LFH.

FIG. 5 illustrates two streams. The first stream is the control stream, block 502 to 548. The second stream, blocks 550 to 560 discloses the path in which the packets are transmitted. The control stream is disclosed by a flowchart with relevant actions of a process 500, which can be executed by an example MDnLFH 330a-n of DOS 300 (FIG. 3), for determining when to switch from FG to BG and vice versa. After initiation 502 process 500 may allocate 504 a counter (Cnt1) for counting the number of bytes that are transferred over the relevant flow; a clock of one millisecond, for example; a timer TiS for measuring the segment period. Next, the duration of a segment can be defined 506. In some example embodiments of LFH the duration can be 100 milliseconds. In other example embodiment the duration can be 10 milliseconds, for example.

At block 508 a segment-table (ST) is allocated. Each row in ST is associated with a segment. The first column indicates the identification (ID) of the segment and the second column indicates the number of bytes that were transferred during that segment. In some example embodiments the ID can point on the starting time of that segment from the beginning of that flow. Next, the duration of the sliding-window (DSW) can be defined 510. The DSW can be in the range of few hundreds of milliseconds to few seconds, 2 seconds for example. In addition a timer for measuring the measuring the size of a sliding-window (SW) can be defined as a TiSW. At this stage the preparation section of process 500 is terminated and the stage of handling the flow starts.

Next a decision is made 520 whether it is the beginning of the flow. If 520 yes, then it can be used as one of the inputs (control 1) to FG gate 530. In some example embodiments of LFH the FG gate 530 can be an or-gate having three inputs. The or-gate can have three inputs (control 1, control 2, and control 3). In some embodiments the leading edge of control 1 can be used. The output of the or-gate can be used as an input to an and-gate the second input to that and-gate can be the flow of packets 550 that are coming from IGW 138 (FIG. 1) and are belong to that flow 552.

Packets that passed the FG gate 530 can be transferred 532 toward the relevant MD, via AGW 134 (FIG. 1) without reducing the bitrate of that flow. In addition the appropriate cell in ST can be updated with the number of bytes that are carried by that packet. Then, a decision is made 534 whether TiSW is smaller or equal to DSW. If 534 yes, this means that the current sliding-window continues. This signal is used as a second control line for FG gate 530.

If 534 is no, this means that the current sliding-window is terminated, then in block 536 the ST is analyzed in order to calculate the Pressure Gauge. The pressure gauge can be calculated as the percentage of the total active time, during that window, from the size of that window. After calculating the Pressure Gauge the ST and the TiSW can be reset 536. Next, a decision is made 538 whether the value of the Pressure Gauge is smaller or equal to TH2. Threshold TH2 can be in the range of 10% to 40%. Some example embodiment of DOS 300 (FIG. 3) may use 30% as the value of TH2.

If 538 the Pressure Gauge is not smaller than TH2, this means that the flow continues to be transmitted in the foreground. Thus this signal is used as the second control line (control 2) of FG gate 530. If 538 the Pressure Gauge is smaller than TH2, it indicates to switch from foreground to background bitrate and this signal can be used as control 5 in order to activate the BG Gate 540.

Returning now to block 520, if it is not the beginning of the flow, then in block 522 a decision is made whether the flow is currently transmitted in FG. In some example embodiments the decision can be based on the relevant entry in the AFT 350 (FIG. 3). If 522 is yes, control line 3 remains true or set to be true for enabling the flow to pass via FG gate 530. If 522 no, control line 4 remains true or set to be true for enabling the flow to pass via BG gate 540. In some example embodiments of LFH the BG gate 540 can be an or-gate having three inputs (control 4, control 5, and control 6). The output of the or-gate can be used as an input to an and-gate the second input to that and-gate can be the flow of packets 550 that are coming from IGW 138 (FIG. 1) and are belong to that flow 552.

Packets that passed the BG gate 540 can be transferred 542 toward the relevant MD, via AGW 134 (FIG. 1) in reducing the bitrate of that flow. In addition the appropriate cell in ST can be updated with the number of bytes that are carried by that packet. Then, a decision is made 544 whether TiSW is smaller or equal than DSW. If 544 yes, this means that the current sliding-window continues. This signal is used as a control line 6 for BG gate 540.

If 544 is no, this means that the current sliding-window is terminated, then in block 546 the ST is analyzed in order to calculate the Pressure Gauge. After calculating the Pressure Gauge the ST and the TiSW can be reset 546. Next, a decision is made 548 whether the value of the Pressure Gauge is bigger or equal to TH1. Threshold TH1 can be in the range of 70% to 90%. Some example embodiment of DOS 300 (FIG. 3) may use 80% as the value of TH1. In some example embodiments reducing the transmitting rate can be implemented by reducing the Receiving-window TCP flag toward the internet server in order to reduce the bitrate that is used by the Internet server for downloading the data packets of the LF. Another example embodiment of the disclosed technique may reduce the transmitting bitrate of a flow that is transmitting toward a MD. Such embodiment may use a FIFO in which the frequency of the read clock is reduced compare to the frequency of the write clock, for example.

If 548 the Pressure Gauge is not bigger than TH1, this means that the flow continues to be transmitted in the background. Thus this signal is used as the second control line (control 6) of BG gate 540. If 548 the Pressure Gauge is bigger than TH1, it indicates to switch from background to foreground transmitting rate and this signal can be used as control 2 in order to activate the FG Gate 530.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

The above description is intended to be illustrative, and not restrictive. For example, the above-described embodiments may be used in combination with each other. Many other embodiments will be apparent to those of skill in the art upon reviewing the above description.

The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein”.

What is claimed is:

1. A non-transitory computer readable memory device comprising executable instructions that when executed cause a processor, at a download optimizer server (DOS):
i. to identify a flow of downloaded packets in the direction toward a first mobile device (MD) from a plurality of MDs that are associated with the download optimizer server (DOS), wherein the download is executed at an initial bitrate;
ii. to reduce the download rate of the flow by a certain percentages.

2. The non-transitory computer readable memory device of claim 1, wherein the DOS is communicatively coupled between the plurality of MDs and a plurality of servers.

3. The non-transitory computer readable memory device of claim 1, wherein the DOS resides at an access network operator premises (ANOP).

4. The non-transitory computer readable memory device of claim 1, wherein the value of the certain percentages is in the range of 10% to 40%.

5. The non-transitory computer readable memory device of claim 1, wherein the value of the certain percentages is 20%.

6. The non-transitory computer readable memory device of claim 1, wherein the instruction to identify a flow further comprising to identify that the flow is a large flow (LF).

7. The non-transitory computer readable memory device of claim 6, wherein identifying that the flow is a LF is based on the application that is used by the MD.

8. The non-transitory computer readable memory device of claim 6, further comprising instructions to calculate the value of a Pressure Gauge of that LF, wherein the Pressure Gauge is a parameter of the flow and is related to the percentages of the active time that is measured at that point of time.

9. The non-transitory computer readable memory device of claim 8, wherein the value of the Pressure Gauge is above a first threshold (TH1) then the transmitting bitrate is switched to the initial bitrate.

10. The non-transitory computer readable memory device of claim 9, wherein the value of the TH1 is in the range of 70% to 90% then the transmitting bitrate is switched to the initial bitrate.

11. The non-transitory computer readable memory device of claim 9, wherein the value of TH1 is 80%.

12. The non-transitory computer readable memory device of claim 8, wherein the value of the Pressure Gauge is below a second threshold (TH2) then the transmitting bitrate is switched to a reduced bitrate.

13. The non-transitory computer readable memory device of claim 12, wherein the value of TH2 is in the range of 10% to 40%.

14. The non-transitory computer readable memory device of claim 12, wherein the value of TH2 is 20%.

15. The non-transitory computer readable memory device of claim 2, wherein the instruction to reduce the download rate of the flow further comprising the instruction to reduce the Receiving-window TCP flag toward a server, from the plurality of servers, that sends that flow.

16. The non-transitory computer readable memory device of claim 2, wherein the instruction to reduce the download rate of the flow is implemented by a first-in-first out (FIFO) memory that is associated with the DOS.

17. The non-transitory computer readable memory device of claim 16, wherein the frequency of the read instruction from the FIFO is reduced compared to the frequency of the write instructions.

18. A system comprises:
a. a download optimizer server (DOS) that is communicatively coupled between a plurality of mobile devices (MDs) and a plurality of servers;
b. wherein the DOS is configured:
i. to identify that a flow of downloaded packets in the direction toward a first MD from the plurality of MDs that are associated with the DOS is a large flow (LF);
ii. to reduce the download rate of the LF by a certain percentage.

19. The system of claim 18, wherein the DOS resides at an access network operator premises (ANOP).

20. The system of claim 18, wherein the value of the certain percentages is in the range of 10% to 70%.

21. The system of claim 18, wherein identifying that the flow is a LF is based on the application that is used by the MD.

22. The system of claim 19, wherein the DOS is configured to calculate the value of a Pressure Gauge of the LF, wherein the Pressure Gauge is a parameter of the LF and is related to the percentages of the active time that is measured at that point of time.

23. The system of claim 18, wherein reducing the download rate of the LF is implemented by reducing the Receiving-window TCP flag toward a server, from the plurality of servers, that sends that flow.
